(19) United States
(12) Patent Application Publication
(10) Pub. No.: US 2020/0164688 A1
(43) Pub. Date: May 28, 2020

(54) METHOD FOR MANUFACTURING TIRE

(71) Applicant: Sumitomo Rubber Industries, Ltd., Kobe-shi (JP)

(72) Inventor: Tomoki KATO, Kobe-shi (JP)

(73) Assignee: Sumitomo Rubber Industries, Ltd., Kobe-shi, Hyogo (JP)

(21) Appl. No.: 16/669,948

(22) Filed: Oct. 31, 2019

(30) Foreign Application Priority Data
Nov. 22, 2018 (JP) 2018-219329

(51) Int. Cl. B60C 9/08

(52) U.S. Cl. CPC B60C 9/08

(57) ABSTRACT

A method for manufacturing a tire, the method includes arranging bead members onto a molding drum on axially both end sides thereof such that outer surfaces of bead reinforcing rubber components of the bead members have bent faces each having an inverse V-shaped manner protruding radially outwardly, winding a non-turn-up carcass ply on the molding drum such that axially both end portions of the non-turn-up carcass ply cover the respective bent faces, joining the axially both end portions of the non-turn-up carcass ply wound on the molding drum to the respective bent faces. The joining includes a first step for reforming each end portion of the non-turn-up carcass ply in an inverse V-shaped manner so as to be along a respective one of the bent faces, and a second step for pressing reformed end portions of the non-turn-up carcass ply onto the respective bent faces using respective press rollers.

### BACKGROUND ART

### Field of the disclosure

The present disclosure relates to a method for manufacturing a tire, and more particularly to a method for manufacturing a tire which includes a carcass ply with both ends terminating in contact with axially outer surfaces of respective bead reinforcing rubber components, e.g., bead apex rubber components.

### Description of the Related Art

For example, the following Patent document 1 discloses in FIG. 1 that a pneumatic tire which includes a carcass including first and second plies arranged adjacently in the tire radial direction, and two axially spaced bead reinforcing rubber components extending radially outwardly from respective bead cores. The first ply which is arranged radially inwardly is configured as a so called turned-up carcass ply which has both ends turned up around the respective bead cores. On the other hand, the second ply is configured as a so called non-turned-up ply which has both ends terminating without being turned up around the bead cores, wherein the both ends are in contact with outer surfaces of the respective bead reinforcing rubber components.

In such a pneumatic tire, a raw tire thereof, for example, is manufactured as follows, using a cylindrical molding drum as illustrated in FIGS. 9A to 9D.

As illustrated in FIG. 9A, a first ply (b) is wound on the molding drum (a). An end portion (b1) of the first ply (b) which is located beyond the molding drum (a) axially outwardly is narrowed down to a relatively small diameter. Next, as illustrated in FIG. 9B, a bead member (e) which includes a bead core (c) and a bead reinforcing rubber component (d) which are integrally joined with one another previously is arranged proximate to the axial end of the molding drum (a) on the end portion (b 1) of the first ply (b). Then, the bead reinforcing rubber component (d) is bent axially inwardly of the drum along the molding drum (a). Thus, the bead reinforcing rubber component (d) is deformed such that an outer surface (ds) thereof is a bent face (f) having an inverse V-shaped manner protruding radially outwardly.

Next, as illustrated in FIG. 9C, a second ply (h) is wound on the first ply (b) so as to cover the bent face (f). After that, since an axial end portion (h1) of the second ply (h) which is positioned beyond the radially outermost peak point (p) of the bent face (f) axially outwardly is separated away from the bent face (f) in the radial direction, the end portion (h1) is placed in an unstable state.

Then, as illustrated in 9D, a portion of the end portion (b1) of the first ply (b) which is located axially outwardly of the bead core (c) is turned up around the bead core (c). Then, the turn-up portion (b1a) is bonded on the end portion (h1) of the second ply (h).

Unfortunately, in the above-mentioned method for manufacturing a raw tire, the first ply (b) is turned up while the end portion (h1) of the second ply (h) is still in an unstable state. Thus, it is difficult to bond the turn-up portion (b1a) to the end portion (h1) accurately, an air may be trapped therebetween. As a result, there is a problem that such a raw tire tends to degrade its vulcanized tire appearance.

### PATENT DOCUMENT

### [Patent Document 1] Japanese Unexamined Patent Application Publication 2004-203129

### SUMMARY OF THE DISCLOSURE

The present disclosure has a major object to provide a method for manufacturing a tire which is capable of preventing an air remaining in the tire, improving appearance of the tire after vulcanization.

According to one aspect of the disclosure, a method for manufacturing a tire, the tire including a tread portion, two axially spaced bead portions including bead members each including a bead core and a bead reinforcing rubber component extending outwardly in a tire radial direction from the bead core, and a carcass including a non-turn-up carcass ply extending between the bead portions through the tread portion and having both ends terminating in contact with outer surfaces in a tire axial direction of the respective bead members, the method includes arranging the bead members onto a molding drum on axially both end sides thereof such that outer surfaces of the bead reinforcing rubber components of the bead members have bent faces each having an inverse V-shaped manner protruding radially outwardly, winding the non-turn-up carcass ply on the molding drum such that axially both end portions of the non-turn-up carcass ply cover the respective bent faces of the bead reinforcing rubber components, joining the axially both end portions of the non-turn-up carcass ply wound on the molding drum to the respective bent faces of the bead reinforcing rubber components, wherein the joining includes a first step for reforming each end portion of the non-turn-up carcass ply in an inverse V-shaped manner so as to be along a respective one of the bent faces, and a second step for pressing reformed end portions of the non-turn-up carcass ply onto the respective bent faces using respective press rollers to join with one another.

In another aspect of the disclosure, the first step may be conducted, using respective reforming rollers each having a sponge layer on an outer circumferential surface thereof, by pressing the axially end portions of the non-turn-up carcass ply toward the respective bent faces to reform the axially end portions of the non-turn-up carcass ply.

In another aspect of the disclosure, each of the press rollers, on its outer circumference, may include a press face having a contour extending along a respective one of the bent faces, wherein the second step is conducted by compressing the press rollers radially inwardly of the molding drum toward the respective bent faces.

In another aspect of the disclosure, the arranging may include arranging the bead members on the molding drum in such a manner that each bead reinforcing rubber component extends radially outwardly from the bead core, and bending the bead reinforcing rubber component of each bead member along the molding drum to shape the outer surface of the bead reinforcing rubber into the bent face.

In another aspect of the disclosure, the arranging may include arranging, on the molding drum, the bead cores which are not integrated with the bead reinforcing rubber components previously, and arranging, on each bead core, the bead reinforcing rubber component whose outer surface is shaped previously into the bent face.

### BRIEF DESCRIPTION OF THE DRAWINGS

FIG. 1 is a cross-sectional view of an embodiment of a tire which is manufactured by a method for manufacturing a tire according to the present disclosure;

FIGS. 2A and 2B are conceptual cross-sectional views of a molding drum for explaining a step for winding a first ply;

FIG. 3 is a partial cross-sectional view of the molding drum for explaining arranging a bead member;

FIGS. 4A and 4B are partial cross-sectional views of the molding drum for explaining a first step and a second step, respectively, in the step of arranging the bead member;

FIG. 5 is a partial cross-sectional view of the molding drum for explaining a step for winding a second ply;

FIGS. 6A and 6B are partial cross-sectional view of the molding drum for explaining a second step and a second step, respectively, in the step of joining;

FIG. 7 is a partial cross-sectional view of the molding drum for explaining a step for turning up the first ply;

FIGS. 8A and 8b are cross-sectional views of the molding drum for explaining the step for arranging the bead member according to another embodiment; and

FIGS. 9A to 9D are partial cross-sectional views of a molding drum for explaining a conventional method for manufacturing a raw tire.

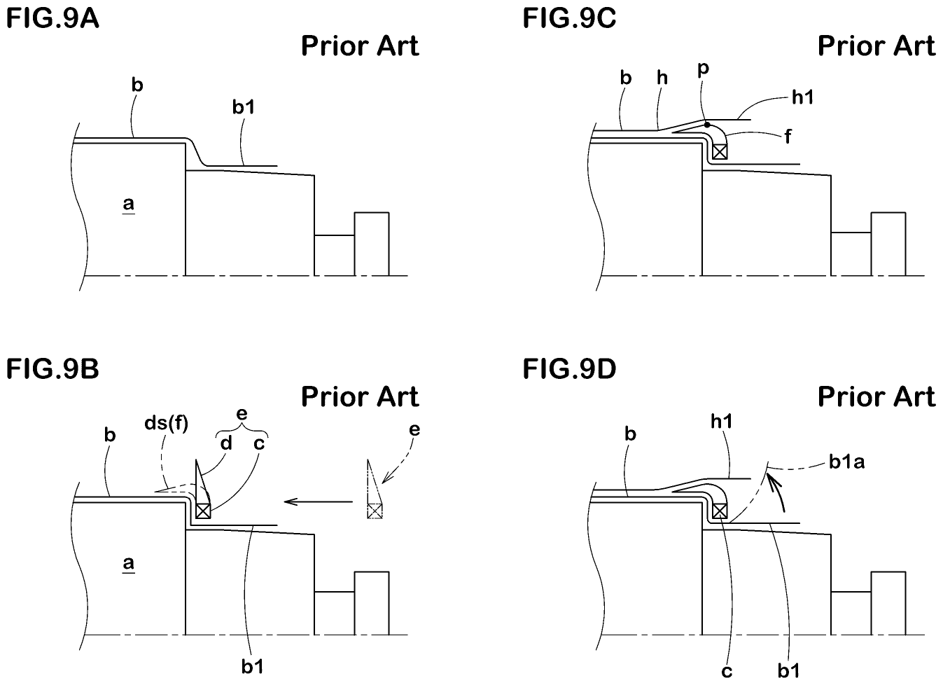

### DESCRIPTION OF THE PREFERRED EMBODIMENTS

An embodiment of the present disclosure will be explained below with reference to the accompanying drawings.

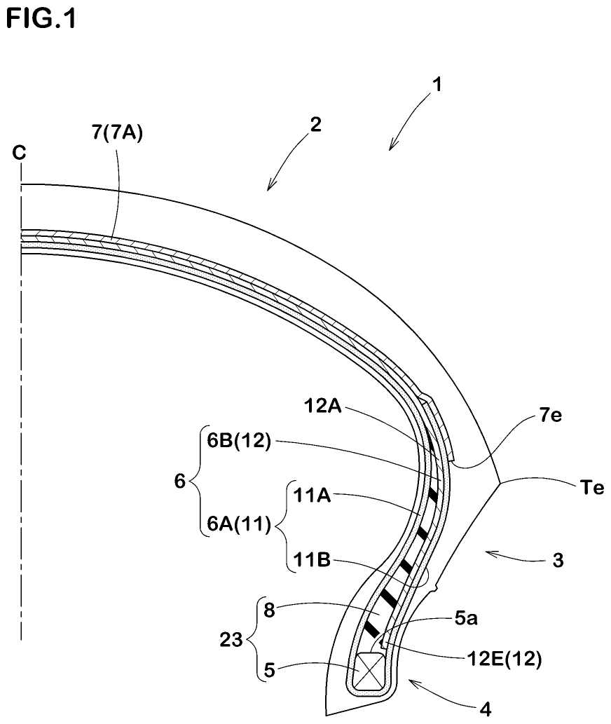

FIG. 1 illustrates a cross-sectional view of an embodiment of a tire 1 which is manufactured by a method for manufacturing a tire according to the present disclosure.

As illustrated in FIG. 1, the tire 1 according to the present embodiment is embodied as a motorcycle pneumatic tire. The present disclosure, however, is not limited to the above aspect but can be modified to various types of pneumatic tires directed to passenger cars, heavy-duty vehicles and the like.

The tire 1 includes a carcass 6 extending between two axially spaced bead portions 4 through a tread portion 2 and sidewall portions 3, and bead members 23 disposed in the respective bead portions 4. Note that FIG. 1 shows only the right half portion of the tire 1.

Each bead member 23 includes an annular bead core 5 made of one or more bead wires, and a bead reinforcing rubber component 8 (e.g., so called bead apex rubber) extending and tapering radially outwardly from an outer surface 5a of the bead core 5.

The carcass 6 includes at least one non-turn-up carcass ply 6B. In the present embodiment, the carcass 6 includes a first ply 11 which is configured as a turn-up ply 6A and a second ply 12 which is configured as the non-turn-up carcass ply 6B. The first ply 11 is disposed radially inside the second ply 12.

The first ply 11 and the second ply 12 each include carcass cords which are arranged at an angle of from 75 to 90 degrees with respect to the tire equator C, for example.

The first ply 11 includes a main portion 11A extending between the bead portions 4 through the tread portion 2, and two axially spaced turn-up portions 11B each of which is connected to the main portion 11A and is turned up around a respective one of the bead members 23 from axially inside to the outside of the tire. In the present embodiment, the turn-up portions 11B terminate at a location which is radially outwardly of the tread edge Te.

The second ply 12 consists of a main portion 12A which extends between the bead portions 4 through the tread portion 2. The second ply 12 has both ends 12E which terminate without being turned up around the bead members 23, and which are in contact with axially outer surfaces of the respective bead members 23. That is, the both ends 12E are sandwiched between the bead member 23 and the turn-up portions 11B. Thus, the both ends 12E are firmly fixed so as to exhibit high carcass-stiffness. Further, this structure makes it possible to prevent deviation of the first ply 11 and the second ply 12.

Each end 12E of the second ply 12 is located at the same height as the outer surface 5a of each bead core 5 or radially outwardly of the outer surface 5a.

The tire 1 according to the present embodiment further includes a tread reinforcing layer 7 disposed radially outwardly of the carcass 6 in the tread portion 2.

As a reinforcing cord ply, one or more belt plies of reinforcing cords orientated at an angle of from 10 to 60 degrees with respect to the tire equator C, for example, and/or one or more band plies of reinforcing cords wound spirally in the tire circumferential direction. In the present embodiment, the tread reinforcing layer 7 is configured as a single belt ply 7A. Alternatively, the tread reinforcing layer 7 may be configured using two or more belt plies, or a combination layer of at least one belt ply and at least one band ply.

Each end 7e of the tread reinforcing layer 7, for example, is placed on each turn-up portion 11B of the first ply 11 to cover the end of the turn-up portion 11B. Thus, each turn-up portion 11B is firmly fixed, enhancing carcass-stiffness further and preventing deviation of the first ply 11.

The tire 1 according to the present embodiment, in addition to the above-mentioned tire construction members, includes conventional inner liner rubber, chafer rubber, sidewall rubber and the like.

Next, a method for manufacturing the tire 1 will be explained. The method for manufacturing includes a raw tire molding step for molding a raw tire of the tire 1 (not illustrated), and a vulcanizing step for vulcanizing the raw tire in a tire mold. As the vulcanizing step, various types of conventional vulcanizing steps can be employed. Thus, note that the detailed explanation of the vulcanizing step is omitted in the specification.

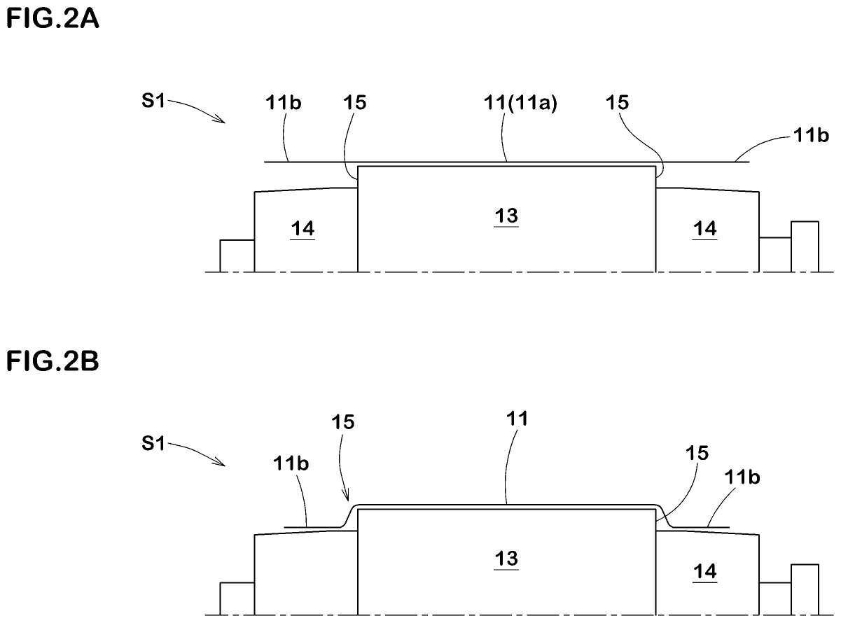

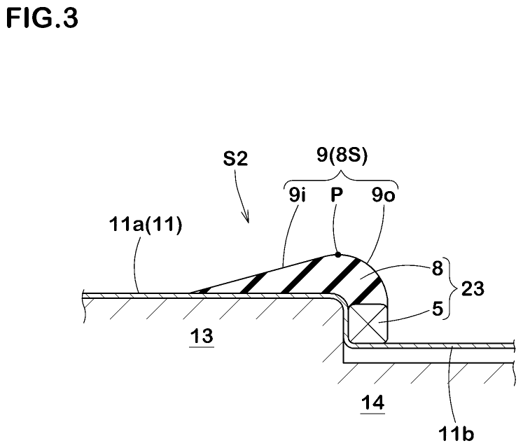

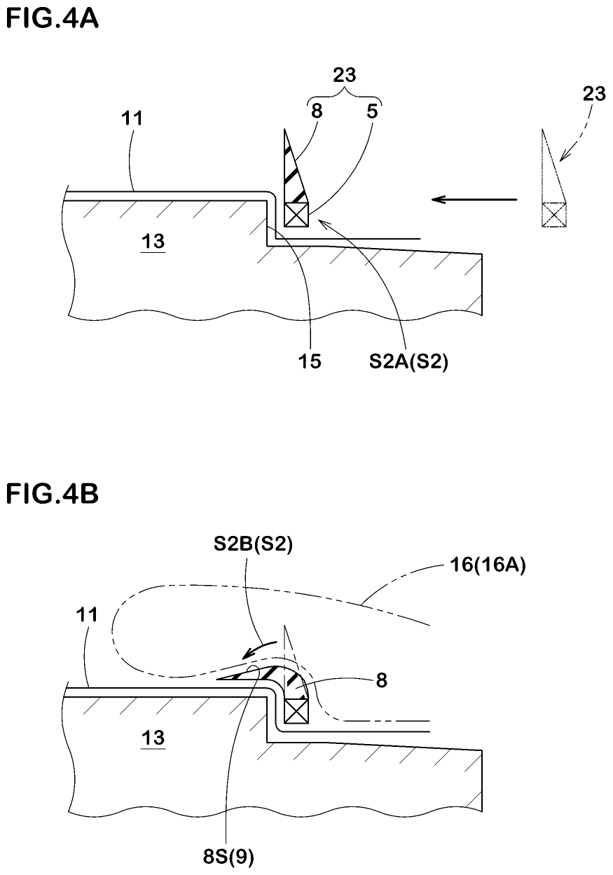

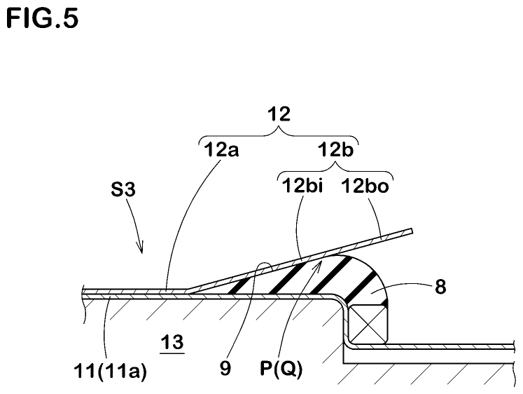

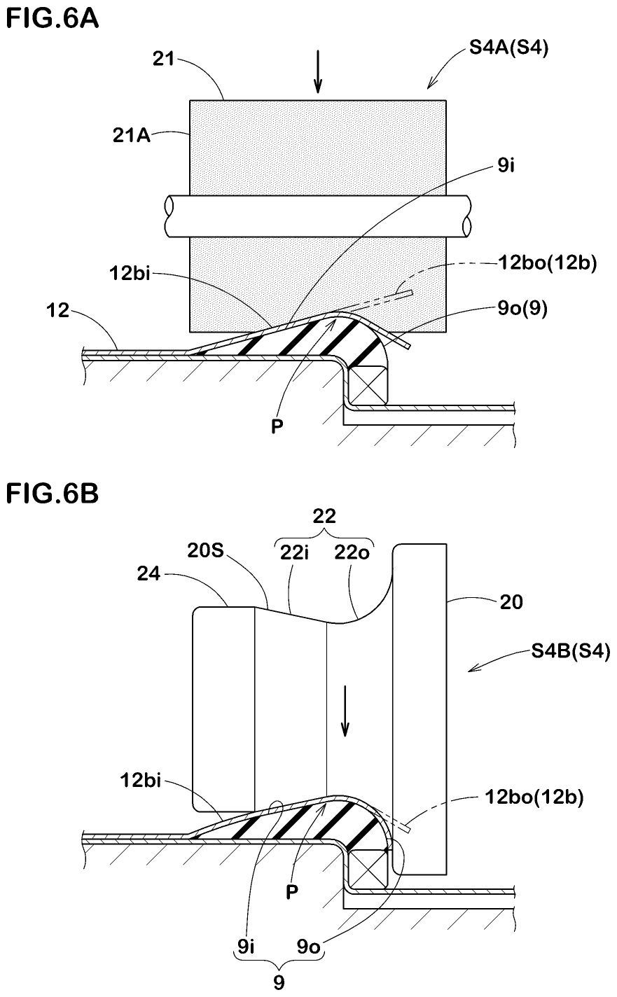

The raw tire molding step, for example, includes a step S2 (illustrated in FIGS. 3 and 4) for arranging the bead members 23, a step S3 (illustrated in FIG. 5) for winding the second ply 12, and s step S4 (illustrated in FIGS. 6A and 6B) for pressing the second ply 12. In the present embodiment, the method, prior to the step S2 for arranging the bead members 23, further includes a step S1 (illustrated in FIGS. 2A and 2B) for winding the first ply 11.

In these steps S1 to S4, a cylindrical molding drum 13 is used. As illustrated in FIG. 2, in the present embodiment, a drum apparatus which includes the molding drum 13 and a pair of side drums 14 provided on axially both end sides of the molding drum 13 is used, for example. The pair of side drums 14 has a smaller diameter than that of the molding drum 13. Thus, step portions 15 are provided between the molding drum 13 and a respective one of the pair of side drums 14. These drums 13 and 14 are arranged so as to have the coaxial center axis, and are capable of rotating integrally around the center axis using an electric motor. As used herein, it is noted that the “axial direction of molding drum” 13 may simply be referred to as “axial direction” or “axially”, and the “radial direction of the molding drum” 13 may simply be referred to as “radial direction” or “radially”.

As the molding drum 13, it is not limited to the above structure, but can be employed various types of drums. For example, although it is not illustrated, the drum apparatus may be configured to include a molding drum, a pair of the side drums, and two bead-locking devices 14 which are arranged between the molding drum and the respective side drums, wherein the molding drum and the pair of side drums have substantially the same outer diameter as with one another. The bead-locking devices are capable of expanding its outer diameter to support radially inner surfaces of the bead core 5 through the first ply 11. In the state that the bead cores 5 are supported by the bead-locking devices, the molding drum 13 can expand with respect to the side drums, thus being formed step portions as the present embodiment.

As illustrated in FIGS. 2A and 2B, in the step Si for winding the first ply 11, the sheet shaped first ply 11 is wound on the molding drum 13. The wound first ply 11 includes a main portion 11a disposed on the molding drum 13, and end portions 11b and 11b which are located beyond the molding drum 13 axially outwardly. As illustrated in FIG. 2B, the end portions 11b are narrowed down to a relatively smaller diameter than an inner diameter of the bead cores 5 so as to be along the step portions 15 using a conventional narrowing-down device.

Prior to the step S1, for example, sheet shaped rubber components such as a chafer, an inner liner, and the like can be wound on the molding drum 13.

Next, the step S2 for arranging the bead members 23 is conducted. Hereinafter, the method is simply explained using only a right side of the molding drum 13. However, note that the same steps of the method may be conducted on the left side of the molding drum 13 in the present embodiment. In the step S2, as illustrated in FIG. 3, each bead member 23 is arranged onto the molding drum 13 on a respective one of axially both end sides thereof. The outer surface 8S of the bead reinforcing rubber component 8 of each bead member 23 has a bent face 9.

The bent face 9 is an inverse V-shaped manner protruding radially outwardly. Specifically, the bent face 9 includes the radially outermost peak point P, an inner inclined face 9i located axially inwardly of the peak point P, and an outer inclined face 90 located axially outwardly of the peak point P.

The step S2, as illustrated in FIGS. 4A and 4B, includes a first step S2A and the second step S2B. In the first step S2A, each bead member 23 which includes the bead core 5 and the bead reinforcing rubber component 8 previously integrated with the bead core 5 is arranged outwardly of each axial end of the molding drum 13. At this time, each bead member 23 is arranged such that the bead core 5 is pushed onto a respective step portion 15.

In the second step S2B, the bead reinforcing rubber component 8 is bent axially inwardly so as to be along the molding drum 13. Thus, the outer surface 8S of the bead reinforcing rubber component 8 is shaped into the inverse V-shaped bent face 9. Note that in the present embodiment, the bead reinforcing rubber component 8 is bent using a bending device 16 which is provided on the side drum 14. The bending device 16, for example, may include a conventional bladder 16A which can expand to lay bead reinforcing rubber component 8 down along the molding drum 13.

Next, as illustrated in FIG. 5, the step S3 for winding the second ply 12 is conducted. In the step S3, the second ply 12 is wound on the molding drum 13 such that second ply 12 cover the respective bent faces 9. The wound second ply 12 includes a main portion 12a which is in contact with the main portion 11a of the first ply 11, and a pair of end portions 12b which extend axially outwardly beyond the respective ends of the main portion 12a. Each end portion 12b includes an axially inner end portion 12bi which is in contact with the bent face 9 of the bead reinforcing rubber component 8, and an axially outer end portion 12bo which is separated from the bent face 9. In the present embodiment, the end portion 12b starts to separate from the bent face 9 at a separation point Q which corresponds to the peak point P. There is a possibility that the separation point Q positions axially inwardly and outwardly with respect to the peak point P according to a shape of the bent face 9 as well as a wound state of the second ply 12.

Next, as illustrated in FIGS. 6A and 6B, the step S4 for joining is conducted. In the step S4, each end portion 12b of the wound second ply 12 is pressed and joined onto each bent face 9. Specifically, the step S4 for joining includes a first step S4A for reforming each end portion 12b in an inverse V-shaped manner so as to be along a respective one of the bent faces 9, and a second step S4B for pressing reformed both end portions 12b onto the respective bent faces 9 using respective press rollers 20 to join with one another.

As illustrated in FIG. 6A, in the first step S4A according to the present embodiment, each of the reforming rollers 21 which has a sponge layer 21A on an outer circumferential surface thereof is used. The reforming rollers 21 are forced to press the respective end portions 12b radially inwardly toward the respective bent faces 9 while being deformed the sponge layer 21A elastically, thus the end portions 12b are reformed in an inverse V-shaped manner.

As a state of the end portions 12b after being reformed, it is sufficient that each outer end portion 12bo is inclined in the same direction as the outer inclined face 9o. That is, in the first step S4A, it is not required that the entire outer end portion 12bo is in contact with the outer inclined face 9o. However, it is preferable that at least a region of and around the peak point P of the outer end portion 12bo is reformed so as to be in contact with the outer inclined face 9o. Here, the “region of and around the peak point” shall mean a region having an axial length from the peak point P over the outer inclined face 90 being equal to or less than 10% of the axial length of the outer inclined face 9o.

As illustrated in FIG. 6B, in the second step S4B, the reformed end portions 12b are pressed onto the respective bent faces 9 using the respective press rollers 20 to join with one another. The press rollers 20 each are a roller having stiffness with an outer surface 20S which includes a press face 22 curved along the bent face 9.

The press face 22 includes an inner press-face portion 22i which is inclined along the inner inclined face 9i and an outer press-face portion 22o which is inclined along the outer inclined face 9o. In the present embodiment, the inner press-face portion 22i has a tapered face with a constant tapered angle, and the outer press-face portion 22o has a circular arc shape having a single radius.

The outer surface 20S, in the present embodiment, includes a cylindrical non-press face 24 on axially inwardly of the inner press-face portion 22i, wherein the non-press face 24 is located away from an axially inner portion of the end portion 12bi of the second ply 12. Thus, pressing force is applied effectively onto region from the peak point P toward the outer inclined face 9o, joining the end portions 12b to the bent face 9 surely.

Here, in the step S4 for joining, if the second step S4B is directly conducted without conducting the first step S4A, wrinkles are formed on the outer end portion 12bo, and thus there is a possibility that an air remains between the outer end portion 12bo and the outer inclined face 9o, as well as between the outer end portion 12bo and the end portion 11b.

Further, when each press roller 20 consists of the outer press-face portion 22o without having the inner press-face portion 22i, a component force toward axially inwardly applies the bead reinforcing rubber component 8 even if the press roller 20 is forced radially inwardly. Thus, the bead reinforcing rubber component 8 tends to be deformed or to deviate toward axially inwardly. From the above viewpoint, it is preferable that the press roller 20 includes both inner press-face portion 22i and outer press-face portion 22o.

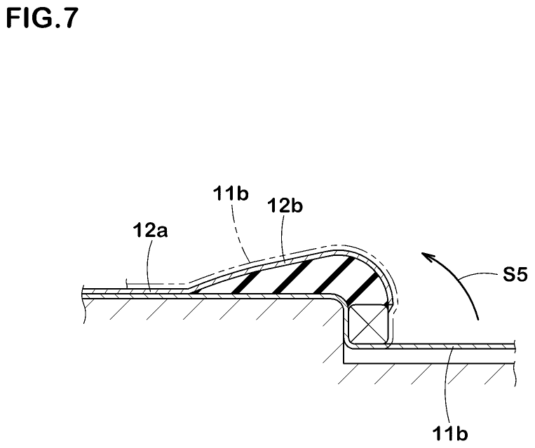

As illustrated in FIG. 7, after the step S4 for joining, a step S5 is conducted such that the end portions 11b of the first ply 11 are turned up around the respective bead members 23. In the step S5, each end portion 11b which was turned up is joined onto an outer surface of the second ply 12 over the end portions 12b and the main portion 12a. In the step for turning up of each end portion 11b, it is not limited but can be conducted using a conventional turning-up bladder (not illustrated) which is provided on the respective side drums 14.

In the method for manufacturing a tire according to the present embodiment, the step S4 for joining can be helpful to join the outer end portion 12bo onto the outer inclined face 9o without wrinkles. Thus, remaining an air between the end portions 11b which was turned up and the outer end portion 12bo can be prevented.

Note that after the step S5 for turning up, the raw tire, for example, is inflated into a toroidal shaped body using a shaping drum (not illustrated), and the toroidal shaped body is joined with a tread member (not illustrated) for forming the tread portion 2. Since the step which is conducted after the step S5 can be conducted as a conventional manner, the detailed explanation is omitted herein.

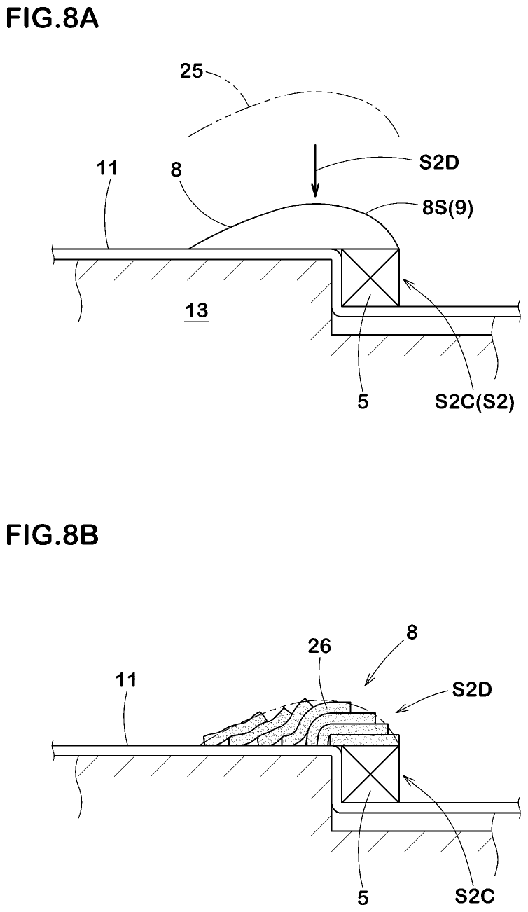

FIG. 8A illustrates another embodiment of the step S2 for arranging the bead member 23. In the present embodiment, the step S2 includes a step S2C for arranging each bead core 5 on a respective one of axially outer end sides of the molding drum 13, and a step S2D for arranging, on the bead core 5, a sideways bead reinforcing rubber component 8 whose outer surface 8S was previously formed into the bent face 9.

As illustrated in FIG. 8A, in the steps S2D, a band-shaped rubber strip 25 which was previously extruded so as to have a cross section having a radially outer surface 8S forming the bent face 9 is used. The rubber strip 25 is wound one turn so as to straddle over the bead core 5 and the molding drum 13, thus forming an annular bead reinforcing rubber component 8.

As illustrated in FIG. 8B, in the step S2D, a ribbon-shaped rubber strip 26 which was previously extruded is used. The rubber strip 26, for example, is wound spirally on the bead core 5 and the molding drum 13 from axially inside to the outside. Thus, an annular bead reinforcing rubber component 8 is formed as a wound body of the rubber strip 26.

While the particularly preferable embodiments in accordance with the present disclosure have been described in detail, the present disclosure is not limited to the illustrated embodiments, but can be modified and carried out in various aspects.

What is claimed is:

1. A method for manufacturing a tire, the tire comprising a tread portion, two axially spaced bead portions comprising bead members each comprising a bead core and a bead reinforcing rubber component extending outwardly in a tire radial direction from the bead core, and a carcass comprising a non-turn-up carcass ply extending between the bead portions through the tread portion and having both ends terminating in contact with outer surfaces in a tire axial direction of the respective bead members, the method comprising:
arranging the bead members onto a molding drum on axially both end sides thereof such that outer surfaces of the bead reinforcing rubber components of the bead members have bent faces each having an inverse V-shaped manner protruding radially outwardly;
winding the non-turn-up carcass ply on the molding drum such that axially both end portions of the non-turn-up carcass ply cover the respective bent faces of the bead reinforcing rubber components;
joining the axially both end portions of the non-turn-up carcass ply wound on the molding drum to the respective bent faces of the bead reinforcing rubber components;
wherein
the joining comprises:
a first step for reforming each end portion of the non-turn-up carcass ply in an inverse V-shaped manner so as to be along a respective one of the bent faces; and
a second step for pressing reformed end portions of the non-turn-up carcass ply onto the respective bent faces using respective press rollers to join with one another.

2. The method for manufacturing a tire according to claim 1, wherein
the first step is conducted, using respective reforming rollers each having a sponge layer on an outer circumferential surface thereof, by pressing the axially end portions of the non-turn-up carcass ply toward the respective bent faces to reform the axially end portions of the non-turn-up carcass ply.

3. The method for manufacturing a tire according to claim 1, wherein
each of the press rollers, on its outer circumference, comprises a press face having a contour extending along a respective one of the bent faces, wherein
the second step is conducted by compressing the press rollers radially inwardly of the molding drum toward the respective bent faces.

4. The method for manufacturing a tire according to claim 1, wherein
the arranging comprises
arranging the bead members on the molding drum in such a manner that each bead reinforcing rubber component extends radially outwardly from the bead core, and
bending the bead reinforcing rubber component of each bead member along the molding drum to shape the outer surface of the bead reinforcing rubber into the bent face.

5. The method for manufacturing a tire according to claim 1, wherein
the arranging comprises
arranging, on the molding drum, the bead cores which are not integrated with the bead reinforcing rubber components previously, and
arranging, on each bead core, the bead reinforcing rubber component whose outer
surface is shaped previously into the bent face.

6. The method for manufacturing a tire according to claim 2, wherein
each of the press rollers, on its outer circumference, comprises a press face having a contour extending along a respective one of the bent faces, wherein
the second step is conducted by compressing the press rollers radially inwardly of the molding drum toward the respective bent faces.

7. The method for manufacturing a tire according to claim 2, wherein
the arranging comprises
arranging the bead members on the molding drum in such a manner that each bead reinforcing rubber component extends radially outwardly from the bead core, and
bending the bead reinforcing rubber component of each bead member along the molding drum to shape the outer surface of the bead reinforcing rubber into the bent face.

8. The method for manufacturing a tire according to claim 3, wherein
the arranging comprises
arranging the bead members on the molding drum in such a manner that each bead reinforcing rubber component extends radially outwardly from the bead core, and
bending the bead reinforcing rubber component of each bead member along the molding drum to shape the outer surface of the bead reinforcing rubber into the bent face.

9. The method for manufacturing a tire according to claim 2, wherein
the arranging comprises
arranging, on the molding drum, the bead cores which are not integrated with the bead reinforcing rubber components previously, and
arranging, on each bead core, the bead reinforcing rubber component whose outer
surface is shaped previously into the bent face.

10. The method for manufacturing a tire according to claim 3, wherein
the arranging comprises
arranging, on the molding drum, the bead cores which are not integrated with the bead reinforcing rubber components previously, and
arranging, on each bead core, the bead reinforcing rubber component whose outer
surface is shaped previously into the bent face.
